(19) United States
(12) Patent Application Publication
(10) Pub. No.: US 2023/0046170 A1
(43) Pub. Date: Feb. 16, 2023

(54) PLEATABLE NONWOVEN

(71) Applicant: North Carolina State University, Raleigh, NC (US)

(72) Inventor: Behnam Pourdeyhimi, Cary, NC (US)

(21) Appl. No.: 17/787,103

(22) PCT Filed: Dec. 15, 2020
(86) PCT No.: PCT/IB2020/061985

§ 371 Date: Jun. 17, 2022

Related U.S. Application Data
(60) Provisional application No. 62/951,313, filed on Dec. 20, 2019.

(51) Int. Cl. B32B 3/28; D04H 3/007; D04H 3/011; B32B 5/02; B32B 5/26; D04H 3/147; D04H 3/16; B32B 7/027

(52) U.S. Cl. CPC B32B 3/28; D04H 3/007; D04H 3/011; B32B 5/022; B32B 5/266; D04H 3/147; D04H 3/16; B32B 7/027; D10B 2505/04; B32B 2262/124; B32B 2262/0253; B32B 2262/0276; B32B 2307/718; B32B 2307/724; B32B 2307/308; B32B 2307/738; B32B 2250/20; B32B 2250/03; B32B 2307/546; B32B 2307/7163

(57) ABSTRACT

The disclosure relates to a pleatable nonwoven fabric including greater than 50% by weight of a majority polymer component, based on total weight of the fabric, and a minority polymer component, wherein there is a difference of at least 10° C. in melting point between the majority polymer component and the minority polymer component, and wherein the fabric is arranged in layers with a first layer, a second layer, and a mid-layer positioned between the first layer and the second layer, and wherein the top layer and the bottom layer comprise a plurality of bicomponent fibers comprising both the majority polymer component and the minority polymer component; and wherein the mid-layer comprises monocomponent fibers constructed from either the majority polymer component or the minority polymer component. A method of making the pleatable nonwoven fabric is also provided.

### FIELD OF THE INVENTION

The present invention relates to pleatable structures comprising a nonwoven substrate formed of a nonwoven material.

### BACKGROUND OF THE INVENTION

Synthetic fibers are widely used in a number of diverse applications to provide stronger, thinner, and lighter weight products. Furthermore, synthetic thermoplastic fibers are typically thermos-formable (pleating and pleating) and thus are particularly attractive for the manufacture of nonwoven fabrics, either alone or in combination with other non-thermoplastic fibers (such as cotton, wool, and wood pulp, for example). Nonwoven fabrics, in turn, are widely used as components of a variety of articles, including without limitation absorbent personal care products, such as diapers, incontinence pads, feminine hygiene products, and the like; medical products, such as surgical drapes, sterile wraps, and the like; filtration devices; interlinings; wipes; furniture and bedding construction; apparel; insulation; packaging materials; and others.

Pleated nonwoven structures are used in a variety of applications. Most notably, filtration and window treatments are the best examples. The type of materials used, the additives used in the polymers, the weight of the nonwoven and the process dictate the shape retention and pleat stiffness. Many nonwovens that are used in these applications are composed of fibers that are larger to facilitate pleat stiffness.

Representative related art in the technology of the invention includes the following patent references: U.S. Pat. No. 2,029,376 to Joseph; U.S. Pat. No. 2,627,644 to Foster; U.S. Pat. No. 3,219,514 to Struycken; U.S. Pat. No. 3,691,004 to Werner; U.S. Pat. No. 4,104,430 to Fenton; U.S. Pat. No. 4,128,684 to Bomio et al.; U.S. Pat. No. 4,212,692 to Rasen et al.; U.S. Pat. No. 4,252,590 to Rasen et al.; U.S. Pat. No. 4,584,228 to Droste; U.S. Pat. No. 4,741,941 to Englebert et al.; U.S. Pat. No. 4,863,779 to Daponte; U.S. Pat. No. 5,165,979 to Watkins et al.; U.S. Pat. No. 5,731,062 to Kim et al.; U.S. Pat. No. 5,833,321 to Kim et al.; U.S. Pat. No. 5,851,930 to Bessey et al.; U.S. Pat. No. 5,882,322 to Kim et al.; U.S. Pat. No. 5,896,680 to Kim et al.; U.S. Pat. No. 5,972,477 to Kim et al.; U.S. Pat. No. 5,993,943 to Bodaghi et al.; U.S. Pat. No. 6,007,898 to Kim et al.; U.S. Pat. No. 6,631,221 to Penninckx et al.; and U.S. Pat. No. 7,060,344 to Pourdeyhimi et al.; and U.S. Appl. Pub. No. 2006/0194027 to Pourdeyhimi et al. The teachings of these references are incorporated by reference herein.

Conventional spunbond fibers are in the range of 1 to 6 denier for most hygiene, medical and filtration applications. Spunbond pleatable media used, for example, in filtration as a scrim, however, have larger fibers to accommodate stiffness. Most are made from polyester polymers (PET, PBT, PTT, etc.) that have a high glass transition temperature. The net result is that the filtration efficiency of these structures is quite low (or non-existent) and, thus, these structures are only used as a support layer for other nonwovens (often meltblown or electrospun structures). There have been many attempts to produce “formable” lightweight structures utilizing the meltblowing technology to improve filtration. See, e.g., European Pat. Nos. 0 848 636 to Legare; 0 498 002 to Aigner et al.; 1 050 331 to Strauss; 1 208 959 to Dickerson et al.; 1 339 477 to Doherty; 2 043 756 to Wu; 2 049 226 to Brandner et al.; 2 162 028 to Angadjivand et al.; and 2 227 308 to Freeman et al.; and U.S. Pat. No. 5,306,321 to Osendorf; U.S. Pat. No. 5,427,597 to Osendorf; U.S. Pat. No. 6,585,838 to Mullins et al.; U.S. Pat. No. 7,326,272 to Hornfeck et al.; U.S. Pat. No. 8,343,251 to Ptak et al.; and U.S. Pat. No. 8,361,180 to Lim et al., each of which is herein incorporated by reference.

Most notably, the pleatable spunbonds commercially available are made from polyester type polymers. This is partly due to the fact that polyesters have high a glass transition temperature and can hold the pleats under normal conditions. These structures are often composed of 6 to 10 denier (or larger) fibers, have larger pores, and low filtration efficiency.

### SUMMARY OF THE INVENTION

The disclosure provides a pleatable nonwoven fabric. Embodiments of the disclosure provide a pleatable structure that can offer filtration at low basis weights while having pleat stability and thermal stability, and further provide a structure processible at high throughputs and which show little or no shrinkage. In certain embodiments, the present disclosure offers fabrics that are recyclable or compostable. In certain embodiments, the fabrics of the present disclosure are useful in a wide range of applications, particularly where pleating is required, such as filtration (e.g., coffee filters, water filters, tea bags, and the like).

In some embodiments, the pleatable nonwoven fabric comprises greater than 50% by weight of a majority polymer component, based on total weight of the fabric, and a minority polymer component, wherein there is a difference of at least 10° C. in melting point between the majority polymer component and the minority polymer component, and wherein the fabric is arranged in layers with a first layer, a second layer, and a mid-layer positioned between the first layer and the second layer, and wherein the top layer and the bottom layer comprise a plurality of bicomponent fibers comprising both the majority polymer component and the minority polymer component; and wherein the mid-layer comprises monocomponent fibers constructed from either the majority polymer component or the minority polymer component. In one embodiment, the bicomponent fibers are islands-in-the-sea fibers with the majority polymer component positioned as the island component.

The majority polymer component can be selected, for example, from the group consisting of PLA, PP, and PET and the minority polymer component can be selected, for example, from the group consisting of PE, PLA, and PP. In some embodiments, majority polymer component is present in an amount of 50 to about 90% by weight and the minority polymer component is present in an amount of about 10 to 49% by weight. In other embodiments, the majority polymer component is present in an amount of about 70 to about 85% by weight and the minority polymer component is present in an amount of about 15 to about 30% by weight. Either or both of the majority polymer component and the minority polymer component can further include a nucleating agent. One or both of the majority polymer component and the minority polymer component are defined by a shrinkage of less than about 10% at a pleating temperature of about 80° C.

In one embodiment, the majority polymer component is PLA and the minority polymer component is PLA and the difference in melting point between the majority polymer component and the minority polymer component is at least 20° C. In another embodiment, the majority polymer component is PP and the minority polymer component is PP. In yet another embodiment, the majority polymer component is PP and the minority polymer component is PE. In a still further embodiment, the majority polymer component is PLA and the minority polymer component is PP. In other embodiments, the majority polymer component is PLA and the minority polymer component is PE. In further embodiments, the majority polymer component is PET and the minority polymer component is PE.

In certain embodiments, the fabric has a basis weight of about 5 g/m² to about 250 g/m², such as about 10 g/m² to about 50 g/m². In certain embodiments, the fibers of all layers have a diameter in the range of about 5 microns to about 60 microns, such as a diameter in the range of about 20 microns to about 40 microns.

In another aspect, the disclosure provides a pleated nonwoven fabric comprising the pleatable nonwoven fabric of any of the embodiments noted herein. In yet another aspect, the disclosure provides a method of making the pleatable nonwoven fabric, comprising simultaneously melt spinning the fibers of all layers by extruding the fibers through a spinneret configured to arrange the bicomponent fibers and the monocomponent fibers in rows, each row containing only fibers of a single type, and forming the fibers into a nonwoven fibrous web. The method can further include mechanically bonding, thermally bonding, or both mechanically and thermally bonding the nonwoven fibrous web, and also further include pleating the nonwoven fibrous web.

In one embodiment, the disclosure provides a 100% PLA pleatable nonwoven medium weighing between 5 g/m² and 250 g/m² comprising: PLA as the first component of about 50-80% or more and a second PLA component with a lower melting point of about 20 degrees C. or more compared to the first component polymer where the second polymer forms a mid-layer in a mixed media structure.

In another embodiment, the disclosure provides a100% PP pleatable nonwoven weighing between 5 g/m² and 250 g/m² comprising: PP as the first component of about 50-80% or more and a second PP component with a lower melting point of about 10 degrees C. or more compared to the first component polymer where the second polymer forms a mid-layer in a mixed media structure.

In another embodiment, the disclosure provides a PP/PE pleatable nonwoven weighing between 5 g/m² and 250 g/m² comprising: PP as the first component of about 50-80% or more and a second PE component with a lower melting point of about 10 degrees C. or more compared to the first component polymer where the second polymer forms a mid-layer in a mixed media structure.

In another embodiment, the disclosure provides a 100% PLA pleatable nonwoven medium weighing between 5 g/m² and 250 g/m² comprising: PLA as the first PLA component of about 50-80% or more and a second PLA component with a lower melting point of about 20 degrees C. or more compared to the first component polymer in a sheath-core, segmented pie islands in the sea or other multicomponent configurations.

In another embodiment, the disclosure provides a 100% PP pleatable nonwoven medium weighing between 5 g/m² and 250 g/m² comprising: PP as the first component of about 50-80% or more and a second PP component with a lower melting point of about 10 degrees C. or more compared to the first component polymer in a sheath-core, segmented pie islands in the sea or other multicomponent configurations.

In another embodiment, the disclosure provides a PP/PE pleatable nonwoven medium weighing between 5 g/m² and 250 g/m² comprising: PP as the first component of about 50-80% or more and a second PE component with a lower melting point of about 20 degrees C. or more compared to the first component polymer in a sheath-core, segmented pie islands in the sea or other multicomponent configurations.

The disclosure includes, without limitations, the following embodiments.

Embodiment 1: A pleatable nonwoven fabric comprising greater than 50% by weight of a majority polymer component, based on total weight of the fabric, and a minority polymer component, wherein there is a difference of at least 10° C. in melting point between the majority polymer component and the minority polymer component, and

wherein the fabric is arranged in layers with a first layer, a second layer, and a mid-layer positioned between the first layer and the second layer, and

wherein the top layer and the bottom layer comprise a plurality of bicomponent fibers comprising both the majority polymer component and the minority polymer component; and

wherein the mid-layer comprises monocomponent fibers constructed from either the majority polymer component or the minority polymer component.

Embodiment 2: The pleatable nonwoven fabric of Embodiment 1, wherein the majority polymer component is selected from the group consisting of PLA, PP, and PET and the minority polymer component is selected from the group consisting of PE, PLA, and PP.

Embodiment 3: The pleatable nonwoven fabric of any one of Embodiments 1-2, wherein the majority polymer component is present in an amount of 50 to about 90% by weight and the minority polymer component is present in an amount of about 10 to 49% by weight.

Embodiment 4: The pleatable nonwoven fabric of any one of Embodiments 1-3, wherein the majority polymer component is present in an amount of about 70 to about 85% by weight and the minority polymer component is present in an amount of about 15 to about 30% by weight.

Embodiment 5: The pleatable nonwoven fabric of any one of Embodiments 1-4, wherein the majority polymer component is PLA and the minority polymer component is PLA and the difference in melting point between the majority polymer component and the minority polymer component is at least 20° C.

Embodiment 6: The pleatable nonwoven fabric of any one of Embodiments 1-5, wherein the majority polymer component is PP and the minority polymer component is PP.

Embodiment 7: The pleatable nonwoven fabric of any one of Embodiments 1-6, wherein the majority polymer component is PP and the minority polymer component is PE.

Embodiment 8: The pleatable nonwoven fabric of any one of Embodiments 1-7, wherein the majority polymer component is PLA and the minority polymer component is PP.

Embodiment 9: The pleatable nonwoven fabric of any one of Embodiments 1-8, wherein the majority polymer component is PLA and the minority polymer component is PE.

Embodiment 10: The pleatable nonwoven fabric of any one of Embodiments 1-9, wherein the majority polymer component is PET and the minority polymer component is PE.

Embodiment 11: The pleatable nonwoven fabric of any one of Embodiments 1-10, wherein one or both of the majority polymer component and the minority polymer component further include a nucleating agent.

Embodiment 12: The pleatable nonwoven fabric of any one of Embodiments 1-11, wherein the fabric has a basis weight of about 5 g/m² to about 250 g/m².

Embodiment 13: The pleatable nonwoven fabric of any one of Embodiments 1-12, wherein the fabric has a basis weight of about 10 g/m² to about 50 g/m².

Embodiment 14: The pleatable nonwoven fabric of any one of Embodiments 1-13, wherein one or both of the majority polymer component and the minority polymer component are defined by a shrinkage of less than about 10% at a pleating temperature of about 80° C.

Embodiment 15: The pleatable nonwoven fabric of any one of Embodiments 1-14, wherein the fibers of all layers have a diameter in the range of about 5 microns to about 60 microns.

Embodiment 16: The pleatable nonwoven fabric of any one of Embodiments 1-15, wherein the fibers of all layers have a diameter in the range of about 20 microns to about 40 microns.

Embodiment 17: The pleatable nonwoven fabric of any one of Embodiments 1-16, wherein the bicomponent fibers are islands-in-the-sea fibers with the majority polymer component positioned as the island component.

Embodiment 18: A pleated nonwoven fabric comprising the pleatable nonwoven fabric of any one of Embodiments 1 to 17.

Embodiment 19: A method of making the pleatable nonwoven fabric of any one of Embodiments 1 to 17, comprising simultaneously melt spinning the fibers of all layers by extruding the fibers through a spinneret configured to arrange the bicomponent fibers and the monocomponent fibers in rows, each row containing only fibers of a single type, and forming the fibers into a nonwoven fibrous web.

Embodiment 20: The method of Embodiment 19, further comprising mechanically bonding, thermally bonding, or both mechanically and thermally bonding the nonwoven fibrous web.

Embodiment 21: The method of any one of Embodiments 19-20, further comprising pleating the nonwoven fibrous web.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### DESCRIPTION OF THE DRAWINGS

Having thus described the present disclosure in general terms, reference will now be made to the accompanying drawings, which are not necessarily drawn to scale, and wherein:

FIG. 1A is the cross section of a sheath-core fiber;

FIG. 1B is the cross section of an island in the sea fiber;

FIG. 2A-2C illustrates various cross sections of side-by-side fibers;

FIG. 3 is the cross section of a pie-wedge or segmented-pie fiber;

FIGS. 4A-4B shows examples of hybrid “mixed media” structures including segmented pie or islands-in-the-sea fibers in combination with a homocomponent fiber;

FIGS. 5A-5B shows additional examples of hybrid mixed media structures with a mid-layer;

FIGS. 6A-6B shows additional examples of hybrid mixed media structures with a multicomponent mid-layer; and

FIGS. 7A-7B illustrates a pleating device and a nonwoven pleated structure.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise.

The present disclosure relates to a pleated fabric structure comprising one or more pleats, and comprising filaments or staple fibers having a diameter of any suitable size, such as below 6 denier per filament. Although nonwoven fabrics are preferred, the fabric structures of the invention can be formed from knitted, braided and woven nonwoven webs. The pleated structure can retain its nonwoven-like quality, but will have significantly different texture as well as resilience for the pleats. The fabrics are typically also compostable or biodegradable.

The pleated fabric structures are formed by a combination of heat and pressure such as those commonly used in solid phase pressure forming, vacuum bladder match plate pleating, stamping, pressing or calendaring. The pleated fabric structure relies on the thermoplastic components in the structure for pleatability.

As used herein, the term “fiber” is defined as a basic element of nonwovens which has a high aspect ratio of, for example, at least about 100 times. In addition, “filaments/continuous filaments” are continuous fibers of extremely long lengths that possess a very high aspect ratio. “Staple fibers” are cut lengths from continuous filaments. Therefore, as used herein, the term “fiber” is intended to include fibers, filaments, continuous filaments, staple fibers, and the like. The term “multicomponent fibers” refers to fibers that comprise two or more components that are different by physical or chemical nature, including bicomponent fibers.

The term “nonwoven” as used herein in reference to fibrous materials, webs, mats, batts, or sheets refers to fibrous structures in which fibers are aligned in an undefined or random orientation. The nonwoven fibers are initially presented as unbound fibers or filaments, which may be natural or man-made. An important step in the manufacturing of nonwovens involves binding the various fibers or filaments together. The manner in which the fibers or filaments are bound can vary, and include thermal, mechanical and chemical techniques that are selected in part based on the desired characteristics of the final product. In certain embodiments, the preferred nonwoven materials are those with a random fiber orientation distribution. While common anisotropic structures can also be pleated, the degree to which they can be drawn becomes more limited with increasing anisotropy.

### Fiber Types

The fibers according to the present invention can vary, and include fibers having any type of cross-section, including, but not limited to, circular, rectangular, square, oval, triangular, and multilobal. In certain embodiments, the fibers can have one or more void spaces, wherein the void spaces can have, for example, circular, rectangular, square, oval, triangular, or multilobal cross-sections. The fibers may be selected from single-component or monocomponent (i.e., uniform in composition throughout the fiber) or multicomponent fiber types (e.g., bicomponent) including, but not limited to, fibers having a sheath/core structure and fibers having an islands-in-the-sea structure, as well as fibers having a side-by-side, segmented pie, segmented cross, segmented ribbon, or tipped multilobal cross-sections. In certain embodiments, the fabrics of the invention will include both monocomponent and multicomponent fibers, and will also typically include more than one type of polymer, either different grades of the same polymer or different polymer types.

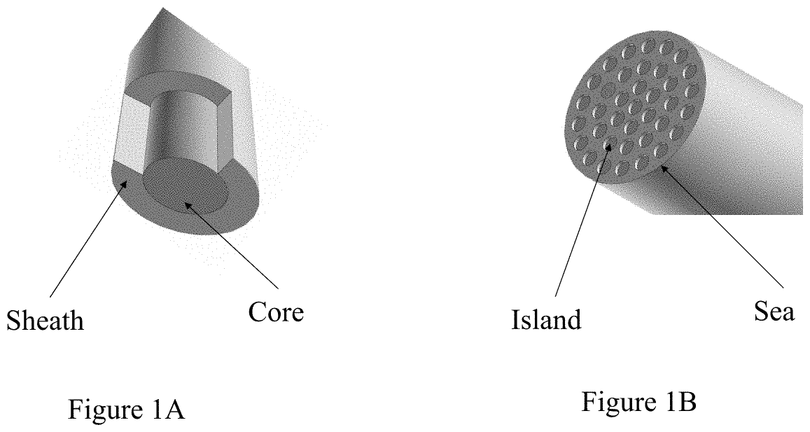

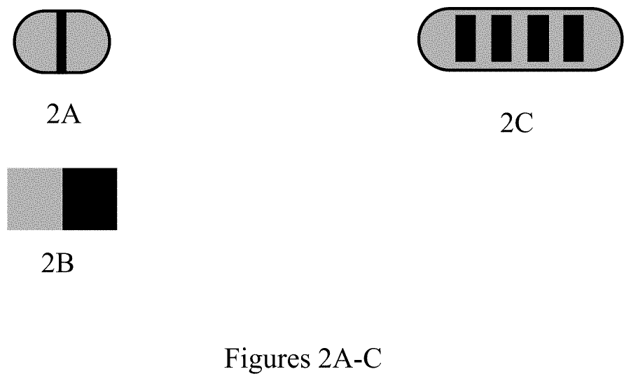

For example, FIG. 1A illustrates a cross-sectional view of an exemplary multicomponent fiber of the present invention. FIG. 1A illustrates a sheath/core fiber that includes at least two structured components: (i) an outer sheath component; and (ii) an inner core component. FIG. 1B illustrates another advantageous embodiment of the invention in which the multicomponent fiber of the invention is a “matrix” or “islands in a sea” type fiber having a plurality of inner, or “island,” components surrounded by an outer matrix, or “sea,” component. The island components can be substantially uniformly arranged within the matrix of the sea component, or the island components can be randomly distributed within the sea matrix. FIG. 2A-C illustrates a side-by-side multicomponent fiber wherein the first component and the second component are arranged in a side-by-side relationship, either in a bicomponent arrangement (e.g., FIGS. 2A and 2B) or in a multicomponent ribbon fiber arrangement (e.g., FIG. 2C).

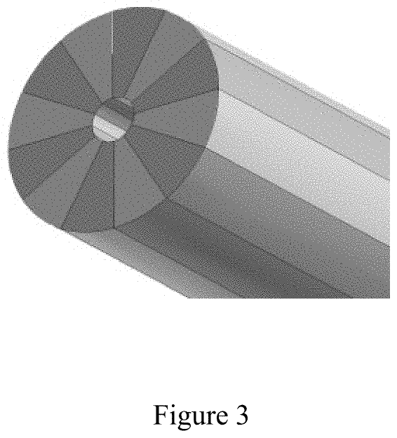

FIG. 3 illustrates an embodiment of the invention wherein the multicomponent fiber is configured in a pie-wedge arrangement, wherein the first component and the second component are arranged as alternating wedges. Although not illustrated, other multicomponent arrangements known in the art are also contemplated in the present invention.

Fiber diameter is a common means of describing fibers with a circular cross-section. In the case of trilobal cross-sections, for example, the longest fiber dimension would be along an edge forming the trilobal cross-section. In the case of ribbon fibers, for example, the cross-section would have two distinct measures (width and thickness). The invention may use fibers of any cross-sectional shape and have a size of about 100 microns or less in diameter (e.g., a round cross-section fiber of about 80 microns in diameter) or wherein at least one of the principal dimension is about 100 microns or less (e.g., a ribbon fiber of about 100 microns x about 10 microns).

Advantageously, the fibers forming the nonwoven web have an average diameter of less than about 30 microns, or less than about 20 microns. The fibers comprising the nonwoven web can have varying lengths and can be substantially continuous fibers, staple fibers, filaments, fibrils, and combinations thereof.

The fibers of the nonwoven web can be in any arrangement. Generally, the fibers are provided in a somewhat random arrangement. Although the present disclosure focuses on nonwoven webs, it is noted that the fibers described herein can also be used to manufacture traditional woven fabrics that can be used in place of, or in addition to, a nonwoven web.

In various embodiments of the present invention, the fibers comprising the nonwoven can be homocomponent, bicomponent or multicomponent; and they can be, for example in a tipped trilobal, side by side, wedge, islands-in-the-sea, or sheath/core configuration. In some embodiments, the nonwoven web is a single layer or multilayer composite made up of one or more spunbound or meltblown structures.

Fibers used in nonwoven substrates can include, for example, one or more thermoplastic polymers selected from the group consisting of: polyesters, co-polyesters, polyamides, polyolefins, polyacrylates, thermoplastic liquid crystalline polymers, and combinations thereof. In some embodiments, the nonwoven can comprise one or more fibers comprising at least one of polyamides, polybutylene terephthalate (PBT), polypropylene, polytrimethylene terephthalate (PTT), polyethylene, polyethylene terephthalate (PET), aliphatic polyesters (e.g., polylactic acid or PLA) co-polyesters, and combinations thereof.

In some cases, fibers are formed by a primary polymer component mixed with a second polymer that acts as a nucleating agent, typically another polymer of the same general type as the primary polymer component. Nucleating agents crystallize prior to the crystallization of the primary polymer melt and aggregate, thereby inducing formation of polymer crystals of the primary polymer. In some embodiments, the nucleating agent can be an elastomeric polymer.

PLA is a slow crystallizer and becomes quite brittle, showing low elongation strain at breaking point. Unless modified, it cannot be used as a proper substitute for applications requiring good elongation. In addition, the heat distortion (also referred to as deflection) temperature (HDT) is around 55-65° C. for most PLA homopolymers, narrowing and limiting their utilization range. When PLA is exposed to hot aqueous environments, the low HDT will cause deformation of the material, rendering it unsuitable for certain pleated fabric applications.

In one embodiment, a high strength bicomponent spunbond PLA nonwoven is made from two different grades of PLA, where the first component is the majority polymer (e.g., 80 to 95% by weight) and is a blend of PLA with another polymer (also biodegradable— less than 10% by weight - for example, Total-Corbion Luminy PDLA D070 which acts as a nucleating agent) to overcome the HDT and shrinkage shortcomings of the PLA, increasing its crystallinity while the secondary polymer is the minority (e.g., 5 to 20% by weight) and is also a PLA that is less crystalline and melts at a temperature at least 10 degrees lower than the majority polymer (for example, NatureWorks 6752D grade of PLA). The lower melting point is achieved by blending PLLA and PDLA. Adding 10% D will reduce the melting point to around 120° C. from 180° C. for the PLLA. The structure will remain compostable, the same as the base PLA polymer. This combination typically will not have any additional additives, plasticizers or the like, and will be expected to exhibit low shrinkage when exposed to temperatures over 80° C.

In another embodiment, the disclosure provides a high strength bicomponent spunbond polypropylene (PP) nonwoven made from two different grades of PP, where the first component is a higher melting point PP than the second grade of PP melts at a lower temperature (at least 10° C. or more). The second PP typically will have a different catalyst that leads to its lower melting point.

In certain embodiments, any of the polymers used herein can be a blend of multiple polymers. For example, the polymer added/blended with a majority polymer PLA can be one or more thermoplastic polymers is selected from the group consisting of polyesters, co-polyesters, polyamides, polypropylene, polyolefins, polyacrylates, thermoplastic liquid crystalline polymers. Specific examples include biodegradable polymers such as polybutylene succinate (PBS), polybutylene succinate)-co-(butylene carbonate) (PBS-co-BC), polyethylene carbonate (PEC), polyhydroxyalkanoates (PHA) such as polyhydroxybutyrate (PHB), poly(glycolic acid) (PGA), polycaprolactone (PCL), and combinations thereof. A very detailed review of polymers suitable for blending with PLA is given in Polylactic Acid: Synthesis, Structures, Properties, and Applications. John Wiley & Sons, p 278. In some embodiments, the one or more thermoplastic polymers described in the above can be utilized as the additive for the majority PLA component in an amount not to exceed 10% by weight of the majority PLA polymer.

### Nonwoven Fabric Formation

Fabrics according to the invention can be formed using, for example, the techniques set forth in U.S. Pat. No. 7,981,336, which is incorporated by reference herein. This patent teaches the formation of mixed fibers in layers. In certain embodiments of the present disclosures, layered fabrics can be formed where, for example, the top and bottom layers can be a sheath core structure (including islands-in-the-sea structures) while the middle layer can be a homocomponent fiber composed of either the sheath or the core polymer. In certain advantageous embodiments, the middle layer and the sheath melt at a lower temperature, which results in a structure that behaves like a laminate, and is therefore, stiff and pleatable. Though not bound by a theory of operation, it is believed that the pleatability comes about because the lower melting polymer is partially melted, deformed, and wrapped or entangled around the other components.

The means of producing the nonwoven web can vary. In general, nonwoven webs are typically produced in three stages: web formation, bonding, and finishing treatments. Web formation can be accomplished by any means known in the art. For example, in certain embodiments, the web may be formed by a drylaid process, a spunlaid process, or a wetlaid process. In some embodiments, the nonwoven web can be prepared by carding, airlay, wetlay, spunbond, meltblown, or hydroentanglement-process, or any combination thereof. In some embodiments, the nonwoven web is made by meltblowing or spunbonding processes.

Spunbonding employs melt spinning, wherein a polymer is melted to a liquid state and forced through small orifices into cool air, such that the polymer strands solidify according to the shape of the orifices. The fiber bundles thus produced are then drawn, i.e., mechanically stretched (e.g., by a factor of 3-5) to orient the fibers. A nonwoven web is then formed by depositing the drawn fibers onto a moving belt. General spunbonding processes are described, for example, in U.S. Pat. Nos. 4,340,563 to Appel et al., U.S. Pat. No. 3,692,618 to Dorschner et al., U.S. Pat. No. 3,802,817 to Matsuki et al., U.S. Pat. No. 3,338,992 and U.S. Pat. No. 3,341,394 to Kinney, U.S. Pat. No. 3,502,763 to Hartmann, and U.S. Pat. No. 3,542,615 to Dobo et al., which are all incorporated herein by reference. Spunbonding typically produces a larger diameter filament than meltblowing, for example. For example, in some embodiments, spunbonding produces fibers having an average diameter of about 20 microns or more. In certain embodiments of the present invention, the nonwoven web comprises spunbound fibers having average diameters in the range of about 5 to about 60, such as about 20 to about 40 microns.

Typically, the plurality of fibers forming the nonwoven web are somewhat fully drawn to ensure low shrinkage. The nonwoven web can comprise a single layer or a multilayer composite made up of one or more spunbound (or meltblown) structures. In certain embodiments, the nonwoven web has a basis weight of about 5 g/m² to about 250 g/m².

In particular embodiments, the method for producing spunbonded nonwoven materials used herein comprises using multiple fiber configurations provided in the same fiber grouping (i.e., from the same spinneret assembly). The resulting nonwoven fiber structure will be composed of a combination of multicomponent fibers with monocomponent or other multicomponent fibers.

The fabrics of the disclosure can include a plurality of fiber types (or groups), wherein each fiber type may be a single monocomponent or bicomponent filament or may be a plurality of monocomponent filaments, bicomponent filaments, or mixtures of monocomponent and bicomponent filaments. A first fiber type can comprise a multicomponent fiber configuration, meaning the fiber or fibers comprise two or more polymers combined in an ordered configuration, such as islands in the sea, segmented pie, segmented ribbon, tipped trilobal, side-by-side, sheath-core, or segmented cross. Example islands-in-the-sea fibers that can be used in the invention include those fibers set forth in U.S. Pat. Appl. Pub. No. 2006/0292355 to Pourdeyhimi et al., which is incorporated by reference herein. The multicomponent fibers used in the disclosure can also comprise the type of multilobal fibers set forth in U.S. Pat. Appl. Pub. No. 2008/0003912 to Pourdeyhimi et al., which is incorporated by reference herein.

The fibers of the second fiber type are preferably dissimilar in structure from the fibers of the first fiber type. The second fiber type can also be in a multicomponent form, including any of the multicomponent forms noted as useful for the first fiber type. Alternatively, the second group of fibers can be monocomponent fibers.

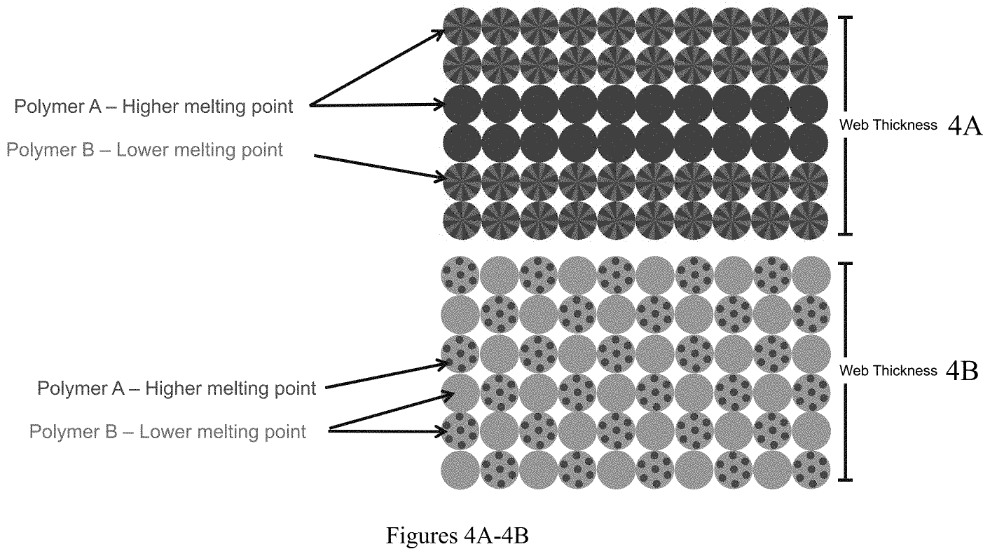

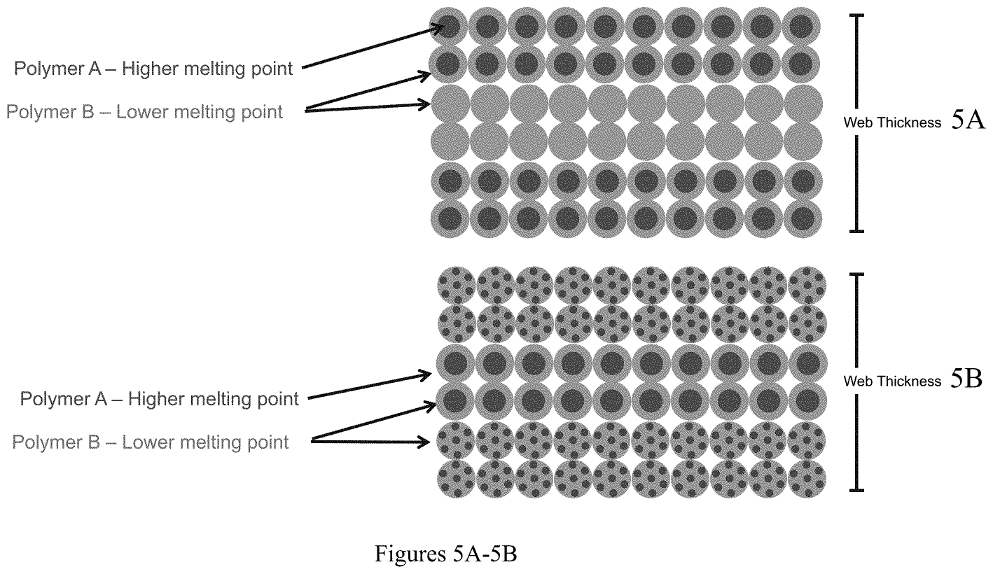

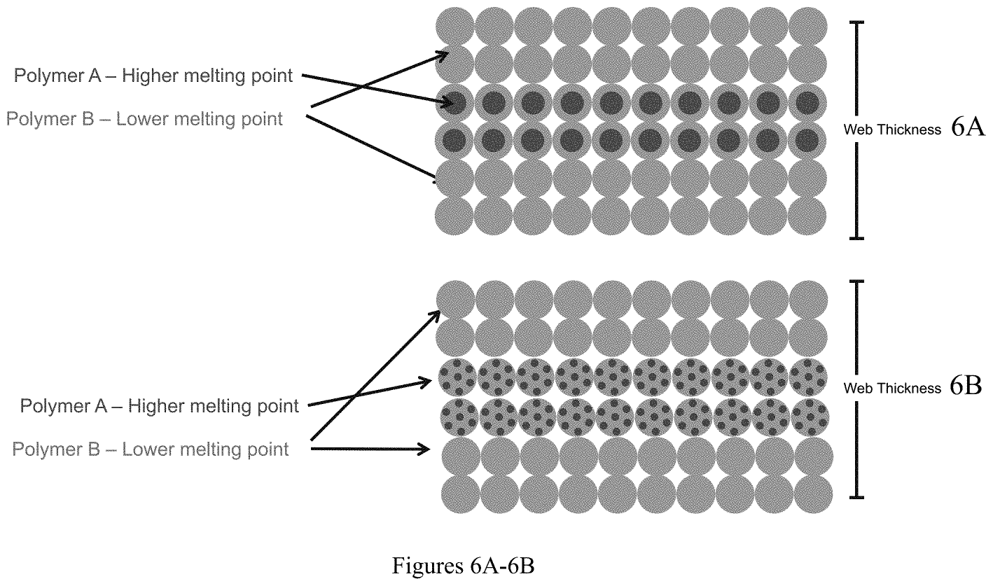

FIGS. 4 through 6 illustrate various mixed fiber structures, typically in layered configurations, that can be used in the present disclosure. For example, FIG. 4A illustrates two layers of segmented pie bicomponent fibers with a mid-layer of monocomponent fibers constructed of the higher melting point component of the segmented pie fibers. FIG. 4B illustrates a uniformly-mixed combination of islands-in-the-sea fibers with a higher melting point material used for the islands and a lower melting point material used for the sea, with interspersed monocomponent fibers constructed of the lower melting point material. FIG. 5A illustrates two layers of sheath-core bicomponent fibers (with higher melting point material core and lower melting point material sheath) with a mid-layer of monocomponent fibers constructed of the lower melting point component of the sheath-core fibers. FIG. 5B illustrates two layers of islands-in-the-sea bicomponent fibers with a mid-layer of sheath-core bicomponent fibers, with a higher melting point material used as the core and island material and a lower melting point material used as the sheath and sea. FIG. 6A illustrates two layers of monocomponent fibers constructed of a lower melting point material with a mid-layer of sheath-core bicomponent fibers, the sheath constructed of the lower melting point material and the core constructed of a higher melting point material. FIG. 6B illustrates two layers of monocomponent fibers constructed of a lower melting point material with a mid-layer of islands-in-the-sea bicomponent fibers, the sea constructed of the lower melting point material and the islands constructed of a higher melting point material.

Although not required to practice the present disclosure, various methods are available for processing multicomponent fibers to obtain fibers having smaller diameters (e.g., less than about 5 microns, less than about 2 microns, less than about 1 micron, less than about 0.5 microns, or even less). For example, in some embodiments, splittable multicomponent fibers are produced (e.g., including but not limited to, segmented pie, ribbon, islands in the sea, or multilobal) and subsequently split or fibrillated to provide two or more fibers having smaller diameters. The means by which such fibers can be split can vary and can include various processes that impart mechanical energy to the fibers, such as hydroentangling. Exemplary methods for this process are described, for example, in U.S. Pat. No. 7,981,226 to Pourdeyhimi et al., which is incorporated herein by reference.

In some embodiments, multicomponent fibers are produced and subsequently treated (e.g., by contacting the fibers with a solvent) to remove one or more of the components. For example, in certain embodiments, an island-in-the-sea fiber can be produced and treated to dissolve the sea component, leaving the islands as fibers with smaller diameters. Exemplary methods for this type of process are described, for example, in U.S. Pat. No. 4,612,228 to Kato et al., which is incorporated herein by reference.

After production of the fibers and deposition of the fibers onto a surface, the nonwoven web can, in some embodiments, be subjected to some type of bonding (including, but not limited to, thermal fusion or bonding, mechanical entanglement, chemical adhesive, or a combination thereof), although in some embodiments, the web preparation process itself provides the necessary bonding and no further treatment is used. In one embodiment, the nonwoven web is bonded thermally using a calendar or a thru-air oven or both. In other embodiments, the nonwoven web is subjected to hydroentangling, which is a mechanism used to entangle and bond fibers using hydrodynamic forces. The term “hydroentangled” as applied to a nonwoven fabric herein defines a web subjected to impingement by a curtain of high speed, fine water jets, typically emanating from a nozzle jet strip accommodated in a pressure vessel often referred to as a manifold or an injector. This hydroentangled fabric can be characterized by reoriented, twisted, turned and entangled fibers. For example, the fibers can be hydroentangled by exposing the nonwoven web to water pressure from one or more hydroentangling manifolds at a water pressure in the range of about 10 bar to about 1000 bar. In some embodiments, needle punching is utilized, wherein needles are used to provide physical entanglement between fibers.

The fibrous webs thus produced can have varying thicknesses. The process parameters can be modified to vary the thickness. For example, in some embodiments, increasing the speed of the moving belt onto which fibers are deposited results in a thinner web. Average thicknesses of the nonwoven webs can vary and in some embodiments, the web may have an average thickness of about 1 mm or less. Additionally, the stiffness of the structure can be controlled by employing larger diameter fibers and/or a higher basis weight. In some embodiments, the basis weight of the nonwoven web is about 500 g/m² or less, about 400 g/m² or less, about 300 g/m² or less, about 200 g/m² or less, about 100 g/m² or less, or about 50 g/m² or less. In certain embodiments, the nonwoven fabric has a basis weight of about 75 g/m² to about 125 g/m². The basis weight of the fabric can be measured, for example, using test methods outlined in ASTM D 3776/D 3776M-09ae2 entitled “Standard Test Method for Mass Per Unit Area (Weight) of Fabric.” This test reports a measure of mass per unit area and is measured and expressed as grams per square meter (g/m²).

With regard to nonwoven substrates, higher porosities can be achieved by using thicker fibers, however, the overall flexibility of the structure will also be reduced, making it more difficult to cut. Therefore, attributes of the nonwoven fabric and fibers can be balanced to achieve the desired resilience, porosity and flexibility. In a preferred embodiment, the nonwoven fabric has a pore size of less than about 500 microns after pleating. In certain embodiments, the structure before being pleated exhibits an air permeability of about 200 cfm to about 1500 cfm, and typically the final pleated structure will have an air permeability in the same range. In some embodiments the pleated structure has an air permeability of less than about 300 CFM, less than about 200 CFM, or less than about 150 CFM. Air permeability can be examined, for example, using test methods outlined in ASTM D 737-04 entitled “Standard Test Method for Air Permeability of Nonwoven Fabrics.” This test method reports a measure of air flowing through the fabric sample in a given area.

As an alternative means for nonwoven web formation, fibers can be extruded, crimped, and cut into staple fibers from which a web can be formed and then bonded by one or more of the methods described above. In some embodiments, staple or filament fibers can be used to form woven, knitted or braided structures as well. In another embodiment of the present invention, staple nonwoven fabrics can be constructed by spinning fibers, cutting them into short segments, and assembling them into bales. The bales can then be spread in a uniform web by a wetlaid process, airlaid process, or carding process and bonded as described above.

### Pleating

The pleated fabric structures are typically formed from the nonwoven web through use of a combination of heat and pressure, such as exemplary conditions utilized in a variety of pleating techniques including solid phase pressure forming, vacuum pleating, bladder pleating, match plate pleating, stamping, pressing, calendaring and the like. Pleating processes that can be adapted for use in the invention are described, for example, in U.S. Pat. No. 7,060,344 to Pourdeyhimi et al., which is herein incorporated by reference in its entirety.

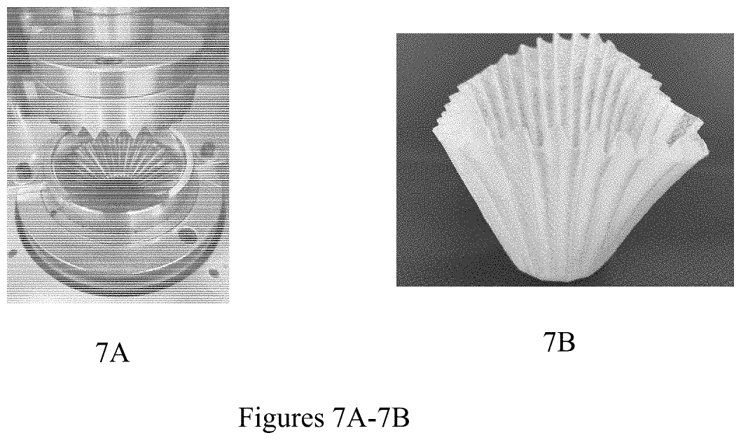

Pleating typically begins with a specific substantially planar nonwoven web. These nonwoven webs are then stabilized and thermoformed using conventional pleating technologies. In some embodiments, multiple layers or composites can be constructed after the forming stage. The forming process can use sheet thermoforming equipment or cup pleating equipment as shown in FIG. 7A. An example of a pleated nonwoven structure is shown in FIG. 7B.

In various embodiments, the tools used to pleat the fabric are heated such that limited heat can be conducted to the fabric during pleating. In other embodiments, the fabric is heated but the tool is at room temperature. In various embodiments, the time required to form the pleated structures can be relatively short, meaning the actual time during which the pleating tools are in contact with the nonwoven web can be brief. Therefore, there can be little time for the fabric to heat up completely in such a process.

The temperature and time necessary for pleating depends on type of substrate being pleated. Specifically, the polymers forming the nonwoven can affect pleating temperatures and times. In various embodiments, the pleating tools can be heated to a temperature of approximately 90° C. to about 160° C. during pleating of the nonwoven substrate. In various embodiments, the time required to form the pleated structures (i.e., the time that the substrate is subjected to the pleating equipment) can be about one second or less, about 1.0 seconds or less, or about 0.3 seconds or less.

Pleating (thermoforming) of nonwoven substrates can be accomplished through a combination of two material phenomena: (1) rheological and (2) mechanical deformation. Rheological deformation implies that a certain amount a molecular movement is induced though the application of heat to the substrate thus softening the fiber to the point of laminar movement. To maintain fibrous characteristics without considerable change to molecular orientation and crystallinity, the forming temperature should be maintained above the glass transition and below the melting temperature (e.g., certain thermoplastic fibers or polymers have a melting temperature between 70-450° C.).

In thermoforming involving deep draws, four fundamental modes of mechanical deformation can be observed. These are in-plane tension, transverse compression, in-plane shear and out-of-plane bending. The complexity in mechanical deformation will vary with the complexity of the pleats.

In an embodiment, the nonwoven comprises one or more fibers, wherein the one or more fibers comprise a thermoplastic polymer defined by a shrinkage of less than about 10% or less than about 5% at the pleating temperature. Shrinkage can be measured for a polymer by forming a spunbond nonwoven web of the polymer material, marking an area of the nonwoven web having a given volume, treating the nonwoven web in an oven at the desired test temperature for a given period of time (e.g., 30 minutes or an hour), and measuring any reduction in volume of the marked area. The difference in volume before and after treatment can be expressed as a percentage change in volume. In certain embodiments, the nonwoven web comprises a thermoplastic polymer capable of being pleated at temperatures below 160° C. to form a depression with a surface area at least two times higher than an initial surface area used to form the depression. In some embodiments, the nonwoven substrate is substantially free of elastic polymers such that the nonwoven substrate comprises less than about 3%, or less then about 2%, or less than about 1%, or less than about 0.5%, by weight of elastomers.

It will be understood that various details of the invention may be changed without departing from the scope of the invention. Furthermore, the foregoing description is for the purpose of illustration only, and not for the purpose of limitation, the invention being defined by the claims.

### EXPERIMENTAL

A number of examples are described below to demonstrate the types of structures that can be deep pleated in the manner described herein. The samples set forth in this experimental were formed using fiber/fabric preparation techniques set forth in, for example, U.S. Pat. Nos. 7,981,336; 7,883,772; 7,935,645; and 7,981,226, all of which are incorporated by reference herein.

In particular, a series of nonwoven spunbond fabrics were prepared with a majority polymer component having a higher melting point and a minority polymer component having a lower melting point. The nonwoven fabrics consisted of a plurality of islands-in-the-sea fibers (37 islands) having the higher melting point component as the island component and the lower melting point component as the sea component, these islands-in-the-sea fibers being present as a top and bottom layer, and an intermediate or “mid-layer” consisting of monocomponent fibers of the lower melting point component. All of the fibers were in the range of 25-30 microns in diameter. In each case, the monocomponent filaments and the bicomponent filaments were extruded through the same spinneret having the pattern shown in FIG. 5A, except instead of using the illustrated sheath/single core outer layers, islands-in-the-sea fibers were used. This design is referred to as a mixed-alternate spin-pack design.

Fabrics were prepared with different combinations of higher/lower melting point polymers, including samples combining two PLA grades, samples combining two PP grades, samples combining PP with PE, samples combining PET and PE, and samples combining PE with PLA. For information about each polymer pairing is set forth below.

The high melting point polymer material, also described as the majority polymer material, and the lower melting point polymer material, also described as the minority polymer material, are set forth in the tables below for each polymer combination. Optionally, in some cases, a nucleating agent can be added to either polymer component to improve the crystallinity and the temperature resistance of the structure. Examples of optional additives of this type are also set forth in the tables.

### PLA/PLA Samples

TABLE 1

| | |
|---|---|
| Majority Polymer Material - Core/Island | NatureWorks |
| | PLA 6100D |
| Optional Additive - nucleating agent L130 PLA | PLA 130 L |
| Minority Polymer Material - Sheath/Sea (and mid-layer) | NatureWorks |
| | PLA 6752D |
| Optional Additive for Sheath/Sea | None |

### PP/PP Samples

TABLE 2

| | |
|---|---|
| Majority Polymer Material - Core/island | PP - 35 MFI - |
| | Exxon 3155 |
| Additive for Core/island | None |
| Minority Polymer Material - Sheath/Sea (and mid-layer) | PP - Exxon |
| | 3854 |
| Optional Additive for Sheath/Sea | VistaMax |

### PP/PE Samples

TABLE 3

| | |
|---|---|
| Majority Polymer Material - Core/island | PP - 35 MFI - |
| | Exxon 3155 |
| Additive for Core/island | None |
| Minority Polymer Material - Sheath/Sea (and mid-layer) | PE - Dow 6835 |
| Optional Additive for Sheath/Sea | Dow Infuse |

### PET/PE Samples

TABLE 4

| | |
|---|---|
| Majority Polymer Material - Core/island | PET - Indorama |
| | 6.6 IV |
| Additive for Core/island | None |
| Minority Polymer Material - Sheath/Sea | PE - Dow 6835 |
| (and mid-layer) | |
| Optional Additive for Sheath/Sea | Dow Infuse |

### PLA/PE Samples

TABLE 5

| | |
|---|---|
| Majority Polymer Material - Core/island | PLA 6100 D - |
| | NatureWorks |
| Optional Additive for Core/island | D070 PDLA - |
| | Total-Corbion |
| Minority Polymer Material - Sheath/Sea (and mid-layer) | PE - Dow 6835 |
| Optional Additive for Sheath/Sea | Dow Infuse |

### Sample Listing

A number of samples were produced using each polymer combination in various polymer weight ratios and basis weights as set forth in Table 6 below.

TABLE 6

| Ratio of Component 1 | | | | | |
|---|---|---|---|---|---|
| to Component 2 | PP/PE | PLA/PE | PET/PE | PP/PP | PLA/PLA |
| 85/15 | 45 gsm | 45 gsm | 45 gsm | | |
| 85/15 | 35 gsm | 35 gsm | 35 gsm | 35 gsm | 35 gsm |
| 85/15 | 25 gsm | | 25 gsm | 25 gsm | 25 gsm |
| 85/15 | 15 gsm | | 15 gsm | 15 gsm | 15 gsm |
| 80/20 | 45 gsm | 45 gsm | 45 gsm | | |
| 80/20 | 35 gsm | 35 gsm | 35 gsm | 35 gsm | 35 gsm |
| 80/20 | 25 gsm | 25 gsm | 25 gsm | 25 gsm | 25 gsm |
| 80/20 | 15 gsm | 15 gsm | 15 gsm | 15 gsm | 15 gsm |
| 70/30 | 45 gsm | 45 gsm | 45 gsm | | |
| 70/30 | 35 gsm | | 35 gsm | 35 gsm | 35 gsm |
| 70/30 | 25 gsm | | 25 gsm | 25 gsm | 25 gsm |
| 70/30 | 15 gsm | | 15 gsm | 15 gsm | 15 gsm |

All samples were calendared (point bonding). The PP/PP and PLA/PLA samples were also bonded by treatment in a thru-air oven after calendaring (point bonding). This resulted in additional bonding and stiffening of the structures with no visible shrinkage during the additional thru-air bonding.

Note that a point bonding pattern was used in the calendaring step. Optionally, a smooth calendar can also be used to increase stiffness if needed. See, e.g., Kim, H. S., Pourdeyhimi, B., Abhiraman, A. S., & Desai, P. (2002). Effect of bonding temperature on load-deformation structural changes in point-bonded nonwoven fabrics. Textile Research Journal, 72(7), 645-653; Kim, H. S., Deshpande, A., Pourdeyhimi, B., Abhiraman, A. S., & Desai, P. (2001). Characterizing structural changes in point-bonded nonwoven fabrics during load-deformation experiments. Textile Research Journal, 71(2), 157-164.

All of the above samples were successfully pleated, although the 15 gsm samples were not as stiff as others. Among the best performers with respect to pleating included those samples with PP in a significant amount, together with PE as the secondary component. Without being bound by a theory of operation, it is believed that the presence of the mid-layer can be particularly helpful in adding stiffness to the fabric, which improves pleatability.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A pleatable nonwoven fabric comprising greater than 50% by weight of a majority polymer component, based on total weight of the fabric, and a minority polymer component, wherein there is a difference of at least 10° C. in melting point between the majority polymer component and the minority polymer component, and
wherein the fabric is arranged in layers with a first layer, a second layer, and a mid-layer positioned between the first layer and the second layer, and
wherein the top layer and the bottom layer comprise a plurality of bicomponent fibers comprising both the majority polymer component and the minority polymer component; and
wherein the mid-layer comprises monocomponent fibers constructed from either the majority polymer component or the minority polymer component.

2. The pleatable nonwoven fabric of claim 1, wherein the majority polymer component is selected from the group consisting of PLA, PP, and PET and the minority polymer component is selected from the group consisting of PE, PLA, and PP.

3. The pleatable nonwoven fabric of claim 1, wherein the majority polymer component is present in an amount of 50 to about 90% by weight and the minority polymer component is present in an amount of about 10 to 49% by weight.

4. The pleatable nonwoven fabric of claim 1, wherein the majority polymer component is present in an amount of about 70 to about 85% by weight and the minority polymer component is present in an amount of about 15 to about 30% by weight.

5. The pleatable nonwoven fabric of claim 1, wherein the majority polymer component is PLA and the minority polymer component is PLA and the difference in melting point between the majority polymer component and the minority polymer component is at least 20° C.

6. The pleatable nonwoven fabric of claim 1, wherein the majority polymer component is PP and the minority polymer component is PP.

7. The pleatable nonwoven fabric of claim 1, wherein the majority polymer component is PP and the minority polymer component is PE.

8. The pleatable nonwoven fabric of claim 1, wherein the majority polymer component is PLA and the minority polymer component is PP.

9. The pleatable nonwoven fabric of claim 1, wherein the majority polymer component is PLA and the minority polymer component is PE.

10. The pleatable nonwoven fabric of claim 1, wherein the majority polymer component is PET and the minority polymer component is PE.

11. The pleatable nonwoven fabric of claim 1, wherein one or both of the majority polymer component and the minority polymer component further include a nucleating agent.

12. The pleatable nonwoven fabric of claim 1, wherein the fabric has a basis weight of about 5 g/m² to about 250 g/m².

13. The pleatable nonwoven fabric of claim 1, wherein the fabric has a basis weight of about 10 g/m² to about 50 g/m².

14. The pleatable nonwoven fabric of claim 1, wherein one or both of the majority polymer component and the minority polymer component are defined by a shrinkage of less than about 10% at a pleating temperature of about 80° C.

15. The pleatable nonwoven fabric of claim 1, wherein the fibers of all layers have a diameter in the range of about 5 microns to about 60 microns.

16. The pleatable nonwoven fabric of claim 1, wherein the fibers of all layers have a diameter in the range of about 20 microns to about 40 microns.

17. The pleatable nonwoven fabric of claim 1, wherein the bicomponent fibers are islands-in-the-sea fibers with the majority polymer component positioned as the island component.

18. A pleated nonwoven fabric comprising the pleatable nonwoven fabric of claim 1.

19. A method of making the pleatable nonwoven fabric of claim 1, comprising simultaneously melt spinning the fibers of all layers by extruding the fibers through a spinneret configured to arrange the bicomponent fibers and the monocomponent fibers in rows, each row containing only fibers of a single type, and forming the fibers into a nonwoven fibrous web.

20. The method of claim 19, further comprising mechanically bonding, thermally bonding, or both mechanically and thermally bonding the nonwoven fibrous web.

21. The method of claim 19, further comprising pleating the nonwoven fibrous web.
